(19) United States
(12) Patent Application Publication
(10) Pub. No.: US 2023/0271350 A1
(43) Pub. Date: Aug. 31, 2023

(54) PLANT AND METHOD FOR RECYCLING HETEROGENEOUS PLASTIC MATERIALS

(71) Applicant: Feti BAHITI, Novara (IT)

(72) Inventor: Feti BAHITI, Novara (IT)

(21) Appl. No.: 18/040,591

(22) PCT Filed: Aug. 4, 2021
(86) PCT No.: PCT/IB2021/057148

§ 371 Date: Feb. 3, 2023

(30) Foreign Application Priority Data
Aug. 4, 2020 (IT) 102020000019249

(51) Int. Cl. B29B 17/04; B29B 13/06; B02C 21/00

(52) U.S. Cl. CPC B29B 17/0412; B29B 13/06; B02C 21/00; B29B 2017/0464

(57) ABSTRACT

A plant of recycling heterogeneous plastic materials comprises: an infeed stage (2) of the plastic material to be recycled, a processing stage (3) of the plastic material fed by said infeed stage (2) and an extraction stage (4) of the plastic material processed in said processing stage (3), wherein said processing stage (3) of the plastic material comprises a rubbing and drying chamber (5) of the fed plastic material suitable for achieving a reduction of the volume and homogenization with drying of the processed material inside said rubbing and drying chamber (5).

### FIELD OF THE INVENTION

The present invention refers to a plant of recycling heterogeneous plastic materials in accordance with the independent claim(s).

According to a further aspect, the present invention also relates to a method of recycling plastic material.

### BACKGROUND OF THE INVENTION

Nowadays, the use of plastic materials of the most varied types is widespread in all sectors, for example, in the packaging of products or for the manufacture of the products themselves.

The main problem arising from the use of plastic materials is related to their disposal after their use. On this point, it is sufficient to consider the quantity of plastic materials to be disposed of in relation to the packaging of the products alone, being they food or other products.

The use of so-called bioplastics has been introduced in the field of packaging of plastic material for food products having a rapid perishability, or of plastic products of the “disposable” type, which biodegrade with the passage of time or, in any case, have characteristics such as to be easily recyclable.

However, the use of bioplastics only is a rather limited percentage of the amount of plastic that we have to dispose of on a daily basis.

Furthermore, it must be considered that the above-mentioned bioplastics do not have such characteristics as to be able to be used in most of the applications for which the use of plastic material is envisaged.

It should also be considered that some plastic materials, such as polyolefins, have characteristics such that they can be easily recycled and reused for the production of new products, while other plastic materials, such as polystyrene, polycarbonate and other thermoplastic materials, are difficult to recycle and, generally, are disposed of by sending them to landfills or to an incinerator.

With reference to the recycling of heterogeneous plastic material, therefore of mixed plastic material as it includes plastic material of different types, although there is the possibility of processing the plastic material in advance to select and at least partially separate the plastic materials by type, it is clear how this selection and separation operation cannot be extreme. Consequently, we find ourselves in the position of being able to carry out a first skimming from the plastics to be recycled, in order to separate the easily reusable materials for a new extrusion/melting cycle, while it remains the problem of being able to process the remaining quantity of plastic material that it cannot be directly reused in extrusion/casting processes with currently known plants and methods.

In order to recycle also the plastic materials that are not easily reusable in the extrusion/melting processes, recycling techniques have been developed and involve the incorporation of these plastics to be recycled, suitably crushed and reduced in size, in a matrix of a plastic material, for example, of polyethylene. In this way, it is possible to manufacture various objects, such as flooring, tiles, road curbs and others, which however show the problem of not being a homogeneous body as they have a structure with internal discontinuous parts not intimately linked to the matrix of polyethylene, with all the consequences that this entails for the structural strength of such objects.

Given the above, it is evident that nowadays the need is felt to be able to recycle heterogeneous plastic materials, i.e. mixed plastic materials, producing a recycled raw material that can be reused in the usual extrusion and/or hot molding processes. in order to manufacture products in plastic materials with good structural characteristics in consideration of the homogeneity of the internal structure.

A further need to be met is to be able to recycle plastic materials with a simplification of both the method and the plants used today, which provide for the implementation of a processing cycle including the phases of spinning, pressing, pneumatic transport, drying with hot air, reduction of the size in the mill and accumulation. In fact, the plants capable of carrying out the above-mentioned steps are structurally complex and expensive, both for the cost of manufacture of the plants and for the energy expenditure required.

### SUMMARY OF THE INVENTION

The problem underlying the present invention is to devise a plant of recycling plastic material that has structural and functional characteristics such as to meet the above-mentioned requirement, while obviating, at the same time, the drawbacks mentioned with reference to the known art.

This problem is solved by a plant of recycling plastic material in accordance with the independent claim(s).

According to a further aspect, this problem is also solved by a method of recycling plastic material in accordance with the independent claim(s).

### BRIEF DESCRIPTION OF THE FIGURES

Further characteristics and advantages of the plant of recycling plastic material according to the present invention will result from the following description of a preferred example of its implementation, given as an indication and not a limitation, with reference to the attached figures, wherein:

FIG. 1 is a simplified perspective view of a plant of recycling of plastic material according to the invention comprising an infeed stage, a processing stage and an extraction stage;

FIG. 2 is a plan view of the front side of the plant in FIG. 1;

FIG. 3 is a plan view of the rear side of the plant in FIG. 1;

FIG. 4 is a plan view of the left side of the plant in FIG. 1;

FIG. 5 is a plan view of the right side of the plant in FIG. 1;

FIG. 6 is a simplified plan view in partial section of the material infeed stage of the plant in FIG. 1;

FIG. 7 is a front plan view with the covers removed of the rubbing and drying stage of the plant material in FIG. 1;

FIGS. 8 and 9 are perspective views with partially removed covers and/or with parts removed from the rubbing and drying stage of the plant material in FIG. 1;

FIGS. 10 and 11 are perspective views from different angles of the roller rotor of the rubbing and drying stage of the plant material in FIG. 1;

FIG. 12 is a partial sectional plan view of a degassing vent of the material processing stage of the plant in FIG. 1;

FIG. 13 is a simplified plan view with partially removed covers of the extraction and process stage of the plant in FIG. 1;

FIG. 14 is a simplified perspective view of the plant in FIG. 1 used as a power supply unit for an extrusion line;

FIG. 15 is a perspective view of a detail of the plant in FIG. 14 with partially removed covers and

FIG. 16 Is a perspective view of a variant of the plant in FIG. 1.

### DETAILED DESCRIPTION OF THE INVENTION

With reference to the attached FIGS., 1 globally indicates a plant of recycling heterogeneous plastic material according to the invention.

Plant 1 of recycling heterogeneous plastic material includes:
an infeed stage 2 for the plastic material to be recycled;
a processing stage 3 of the plastic material fed by the above-mentioned infeed stage 2 and
an extraction stage 4 of the plastic material processed in the above-mentioned processing step 3.

Advantageously, the above-mentioned one processing stage 3 of the plastic material comprises a rubbing and drying chamber 5 of the fed plastic material suitable for achieving a reduction in the volume and homogenization of the processed material inside the rubbing and drying chamber 5.

In accordance with the shown embodiment, the above-mentioned rubbing and drying chamber 5 for the plastic material comprises:
a tubular body 6 extending in a prevailing axial direction X-X and having a continuous side wall 6a extending between opposite closed ends 6b;
a roller rotor 7 comprising a continuous side wall 7a extending axially in the above-mentioned axial direction X-X between opposite closed ends 7b, said roller rotor 7 being:
   rotatably extended, preferably extended inside the tubular body 6 and
   rotatably supported in the tubular body 6 around its own axis,

wherein the external side of the above-mentioned side wall 7a of the roller rotor 7 is spaced from the internal side of the above-mentioned side wall 6a of the tubular body 6 so that in the rubbing and drying chamber 5 an annular cavity 8 is identified, intended to receive the plastic material to be subjected to rubbing, homogenization and drying;
motor means 9 to rotate the above-mentioned roller rotor 7 around its axis of rotation inside the rubbing and drying chamber 5;
a loading opening and a discharge opening for the plastic material to be subjected to rubbing, homogenization and drying, said loading and unloading openings of the rubbing and drying chamber 5 being axially offset from each other in the axial direction X-X and being placed in communication by fluid between them through the above-mentioned annular cavity 8, so that it's identified a processing path inside the rubbing and drying chamber 5 for the plastic material to be subjected to rubbing, homogenization and drying.

Preferably, the above-mentioned loading opening and the above-mentioned discharge opening of the rubbing and drying chamber 5 are positioned in correspondence with axially distal portions of the continuous side wall 6a of the tubular body 6.

Preferably, the above-mentioned extraction stage 4 is associated with the above-mentioned discharge opening of the rubbing and drying chamber 5.

As can be seen from the Figures, the roller rotor 7 has dimensions that almost completely fill the volume of the tubular body 6, with the exception of the annular interspace 8 and two interstices, which will be referred to below, present at the opposite ends 7b of the roller rotor 7.

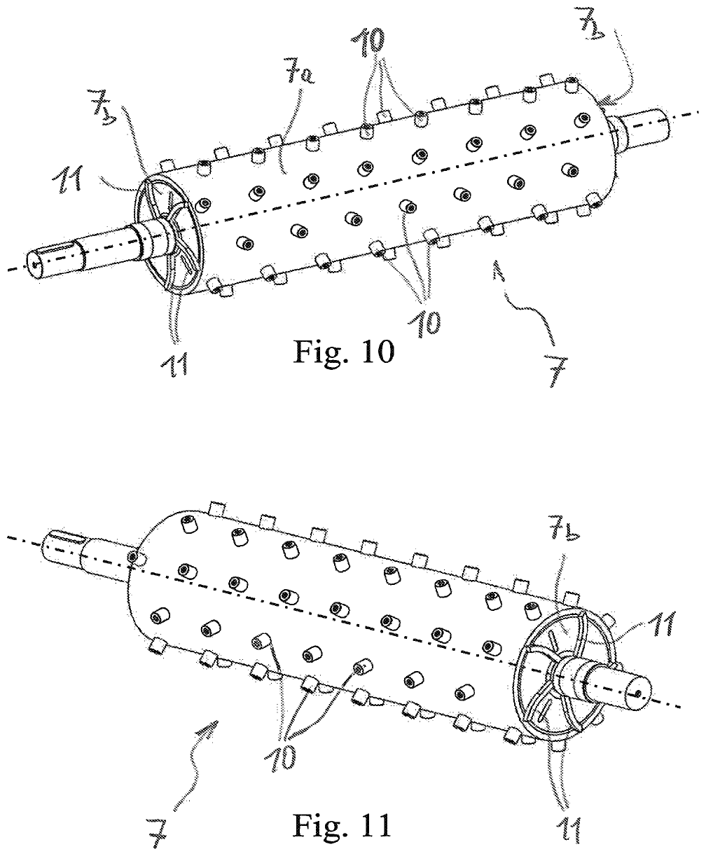

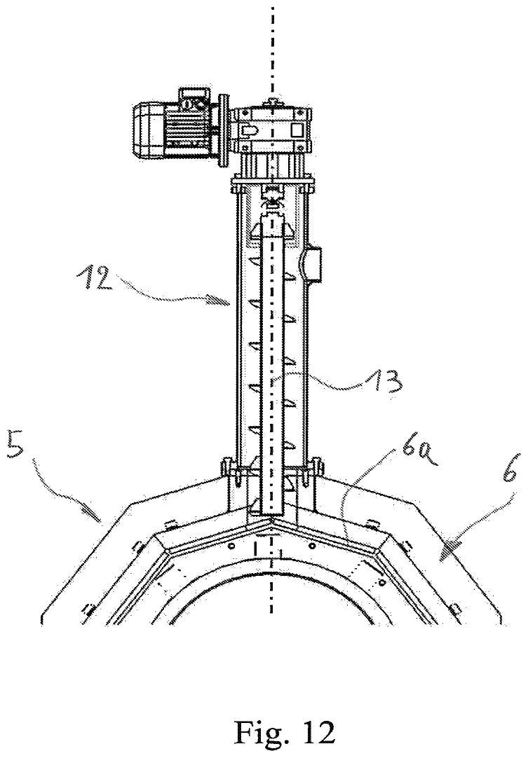

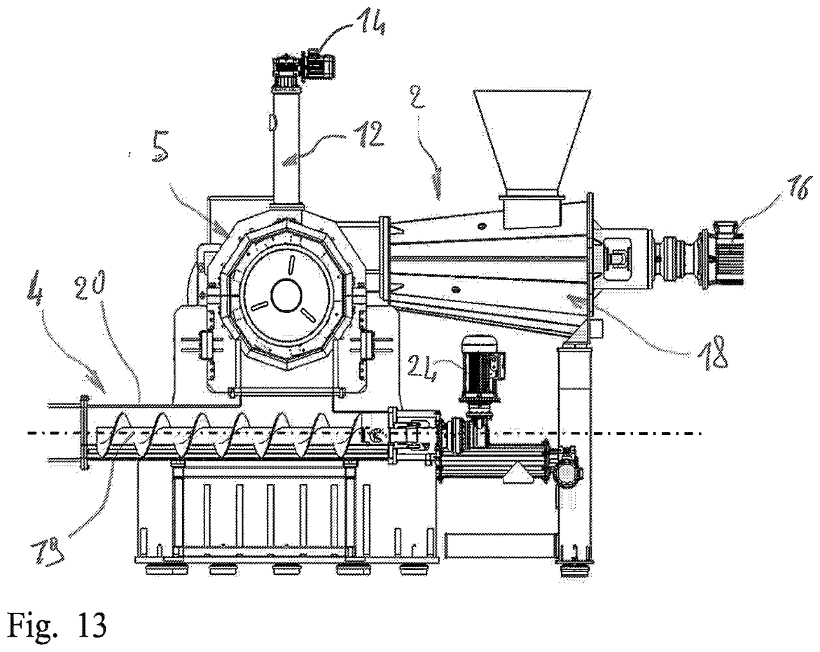

In accordance with the shown embodiment, the roller rotor 7 comprises a plurality of single discontinuous protrusions 10 (see FIGS. 10 and 11) projecting from the continuous side wall 7a towards the inner side of the above-mentioned continuous side wall 6a of the tubular body 6, therefore projecting into the cavity 8.

It should be pointed out that the above-mentioned single discontinuous protrusions 10 are interrupted before interfering with the internal side of the continuous side wall 6a of the tubular body 6.

Preferably, the above-mentioned single discontinuous protrusions 10 are axially and angularly offset from each other and during the rotation of the roller rotor 7 said single discontinuous protrusions strike individually the plastic material present inside the cavity 8 so as to cause its homogenization and reduction of volume by rubbing.

Preferably, the above-mentioned single discontinuous protrusions 10 identify pegs projecting from the side surface of the roller rotor 7.

Therefore, during the rotation of the roller rotor 7 the above-mentioned single discontinuous protrusions 10 come into contact with the plastic material present in the cavity 8.

The impact of the protrusions on the plastic material contained in the cavity 8 allows the fibers of the plastic material to be broken, thus enabling the homogenization of said processed plastic material even in the presence of plastic materials of different nature.

It should be noted that the rubbing with drying of the plastic material inside the cavity 8 allows the temperature of this plastic material to be raised, up to values of up to 150° C.

The temperature increase of the plastic material within the processing stage 3, allows to ensure an effective drying of the plastic material during its homogenization.

Despite this, in accordance with a preferred embodiment, the rubbing and drying chamber 5 comprises heating means, for example electric resistors, suitable for ensuring a heating of the plastic material inside the rubbing and drying chamber 5, more specifically inside the cavity 8, even in an initial transient phase during the initial start-up of the plant.

Preferably, the above-mentioned heating means allow the processed material to reach a temperature of at least 150° C. inside the cavity 8b, more preferably a temperature between 150° C. and 200° C.

These temperature values allow the plastic material present inside the cavity 8 to be brought to a softened or pasty state of semi-melting, such as to allow an intimate homogenization of the heterogeneous plastic materials contained therein.

It is evident that the temperature value to which the plastic material is brought during the processing inside the cavity 8 of the rubbing and drying chamber 5 depends on the type and percentage of the various plastics present to be recycled, being the melting or softening temperature of the various plastics different according to the type of plastic material.

Therefore, the value of the operating temperature at which the rubbing with drying of the plastic material to be recycled takes place depends on the composition and quantities of the different plastics present in the heterogeneous mixture of material to be recycled.

According to a preferred and advantageous embodiment, the above-mentioned heating means associated with the rubbing and drying chamber allow to heat the plastic material inside the above-mentioned rubbing and drying chamber 5 up to values close to 400° C. This ensures that, in the event of a blockage of the plant 1 due to a malfunction, or if it is required to stop the plant, the plastic material contained in the cavity 8 of the rubbing and drying chamber does not solidify by compacting in this cavity 8, but rather reaches temperature values such as to make the plastic material definitely fluid or completely softened regardless of its composition.

Preferably, the continuous side wall 6a of the tubular body 6 is formed or lined with plates, preferably interchangeable, of wear-resistant steel.

Preferably the above-mentioned tubular body 6 has a polyhedral cross section with flat sides connected/converging in corresponding common vertices, which proved to be an excellent compromise between the need to allow the rotation of the rotor and the need to produce a high impact and a high rubbing of the plastic material processed inside the cavity 8 of the rubbing and drying chamber

In accordance with a preferred embodiment, at each of its opposite ends 7b, the roller rotor 7 comprises a plurality of segments 11 projecting from a central portion of the end 7b towards the peripheral edge of the end according to an inclined/arched course.

These segments 11 configure propellers that, during the rotation of the roller rotor 7 inside the tubular body 6, expel any plastic material present in the cavity identified between each end 7b of the roller rotor 7 and the corresponding closed head 6b of the tubular body 6.

In accordance with the shown embodiment, the rubbing and drying chamber 5 is provided with at least one degassing chimney 12. In the example in the Figure, there are four axially spaced apart in the axial direction X-X.

Each degassing chimney 12 is in fluid communication with the cavity 8 and with the external environment.

Furthermore, the rubbing and drying chamber 5 may include openings for the introduction into the cavity 8 of additives (for example, soda or other elements) that can interact with the plastic material during the rubbing with drying step.

Optionally, the above-mentioned openings for the introduction of additives can be combined with the above-mentioned degassing chimneys, in order to exploit the ducts of the degassing chimneys 12 to introduce the desired additives.

Preferably, each degassing stack 12 comprises inside a drive screw 13 driven in rotation by motor means 14, the helical course of the drive screw 13 is such as to induce during rotation a transport/dragging of solid material towards the cavity 8, thereby preventing plastic material from escaping from the cavity 8 through the degassing chimneys 12 or clogging said degassing chimneys.

The function of the degassing chimneys 12 is that of the outlet from the cavity 8 of the rubbing and drying machine chamber of vapors and gases generated by the rubbing with drying of the plastic material, and then convey them to a possible filter.

By degassing the plastic material carried out in the rubbing and drying chamber, it is possible to extract any type of gas and vapor from the machine. The suction, both forced and non-forced, of the degassing chimneys conveys the exhalations to a special filtering plant that allows to purify and condense the extracted vapors, thus allowing the recovery of distilled water or the solvents used by the plant.

The processing stage 3 thanks to the high friction rubbing of the plastic material allows to achieve a homogenization of the heterogeneous plastic material and also a simultaneous drying of the processed plastic material, this drying being favored by the temperatures reached in this stage and/or by the degassing carried out.

As regards the infeed stage 2 of the plastic material to be recycled, in accordance with the shown embodiment, it comprises a feeding screw 15 acting in a containment chamber 18 and operated by motor means 16 to force the introduction of plastic material to be processed in the processing stage 3 with a predetermined adjustable load. Preferably, the above-mentioned feeding screw 15 of the inlet and feeding stage 2 is a conical screw acting in a conical containment chamber 18, with both tapers oriented so as to converge towards the processing stage 3.

Preferably, the walls of the above-mentioned containment chamber 18 have drainage openings and/or are identified by a net, so as to allow the drainage of liquids following the compression and squeezing action carried out on the plastic material in the containment chamber 18 by of the feeding auger 15.

As regards the extraction stage 4 of the plastic material processed in the processing stage 3, in accordance with the shown embodiment, it comprises an extraction screw 19 acting in a containment chamber 20 and operated by motor means 24, preferably an extraction screw 19 acting in an extraction chamber 20.

Similarly to what is provided for the processing stage 3, the extraction stage 4 also comprises heating means, for example, electrical resistors associated with the extraction screw 19 and/or its containment chamber 20, to ensure heating of the plastic material in transit through the extraction stage 4, preferably to ensure a temperature of at least 150° C., more preferably a temperature between 150° C. and 200° C., more preferably to allow the plastic material to be heated inside the extraction stage 4 up to a value close to 400° C., in order to guarantee, during use, that the complete melting of the plastic material can be ensured inside the extraction stage 4.

Therefore, the extraction stage 4 provides for a forced exit from the rubbing and drying chamber 5 of the processed material. As mentioned, the processed plastic material is in the semi-melted or pasty state and, if necessary, this state can be maintained, or even increased, even in the extraction stage 4 thanks to the presence of the heating means.

It should be noted that the mixing of the processed material within the extraction stage 4 allows for a real phase of further amalgamation/homogenization of the material. For this purpose, the length of the extraction stage 4, in particular of its extraction screw 19, can be determined in the plant design phase based on the result to be achieved.

In accordance with a preferred embodiment, the plant 1 comprises:
means for controlling the current absorption of said motor means 9 of the roller rotor 7 around its own axis inside the rubbing and drying chamber 5;
first control means for varying the speed of rotation of the motor means 16 of the feeding screw 15 of the input stage 2;
second control means for varying the speed of rotation of the motor means 24 of the extraction screw 19 of the extraction stage 4 and
means to check the current absorption of the motor means 9 of the roller rotor 7 and compare it with a preset current absorption value, so as to:
feedback control the above-mentioned first control means to increase or decrease the speed of rotation of the motor means 16 of the feed screw 15 of the input stage 3 depending on whether the detected absorption value is lower or, respectively, higher than the above-mentioned preset current absorption value and/or
feedback control the above-mentioned second control means to increase or decrease the speed of rotation of the motor means 24 of the extraction screw 19 of the extraction stage 4 depending on whether the detected absorption value is higher or, respectively, lower than the above-mentioned preset current absorption value.

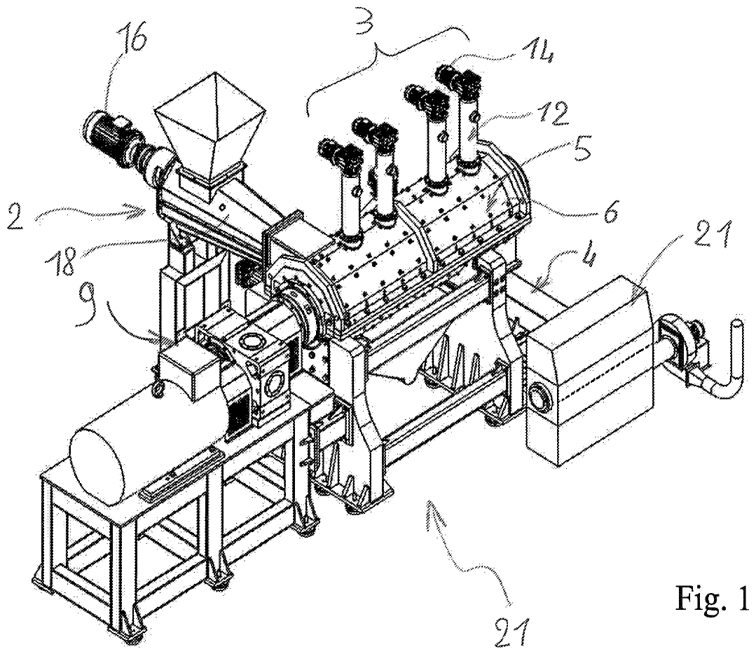

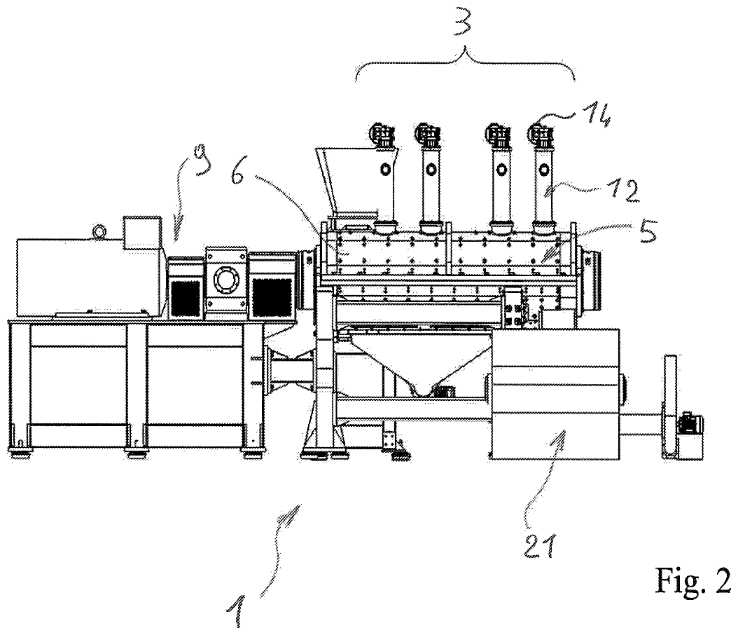

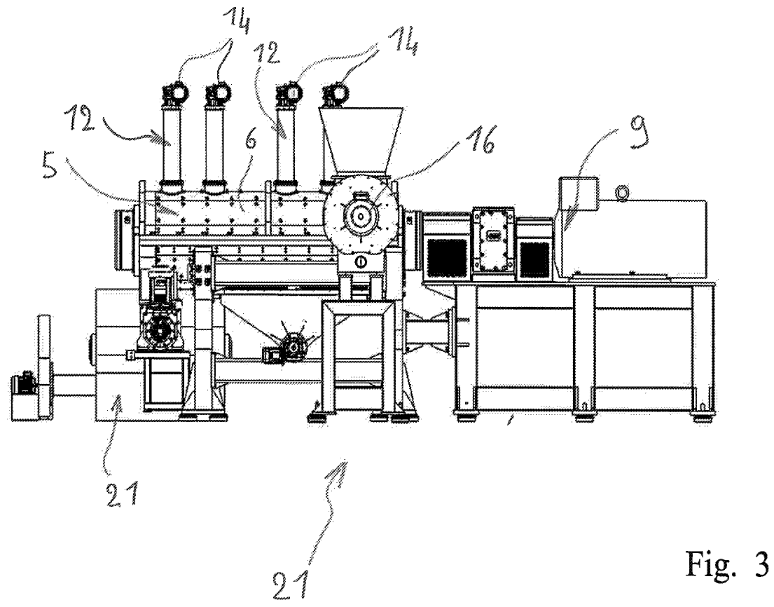

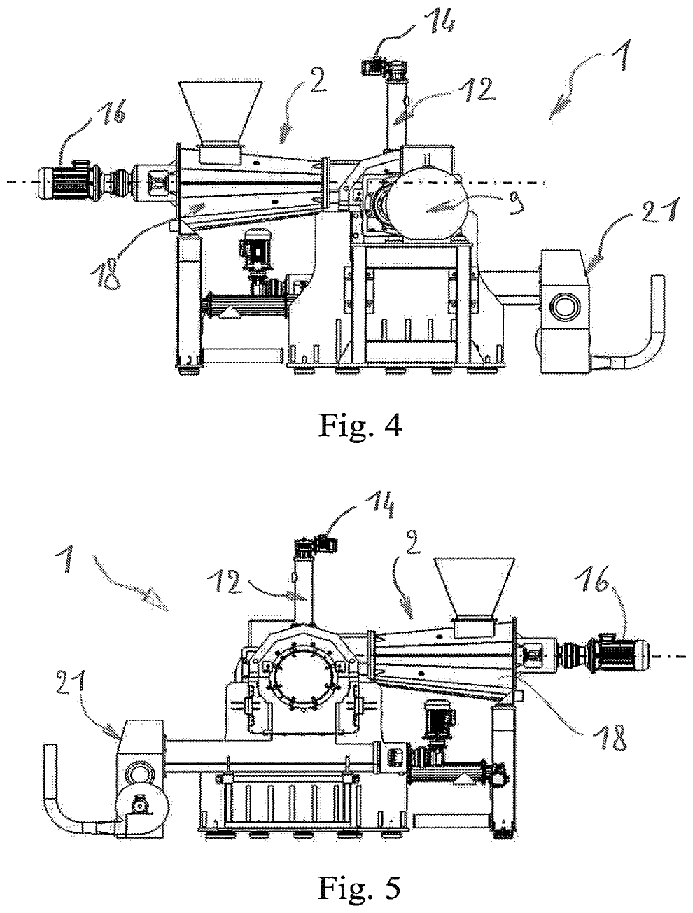

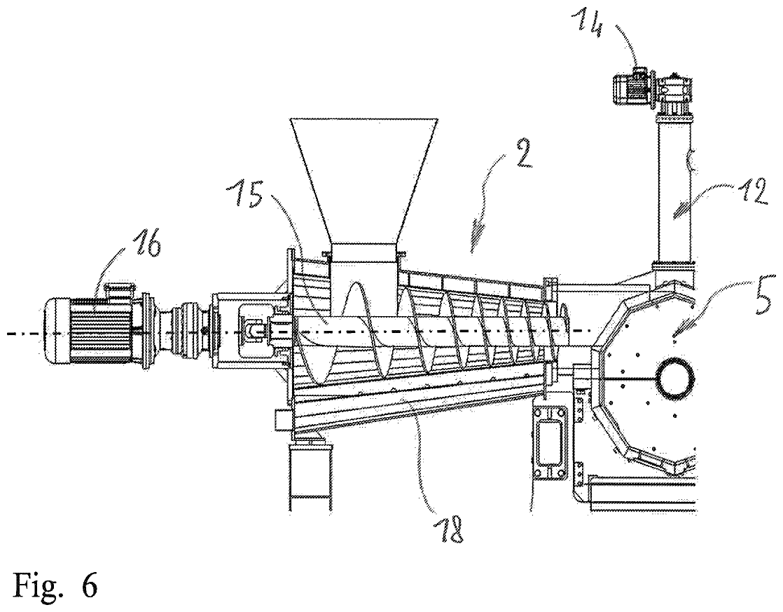

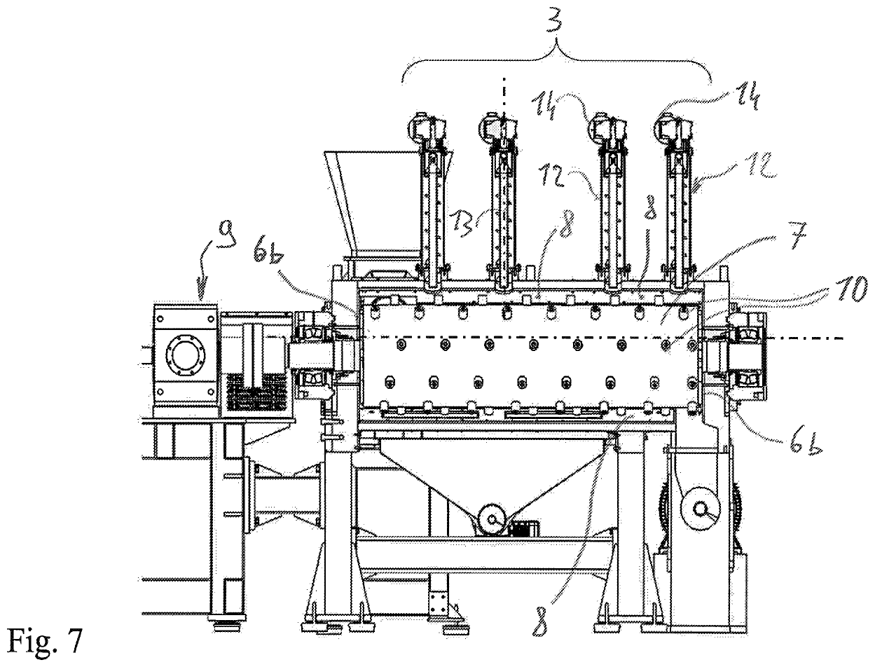

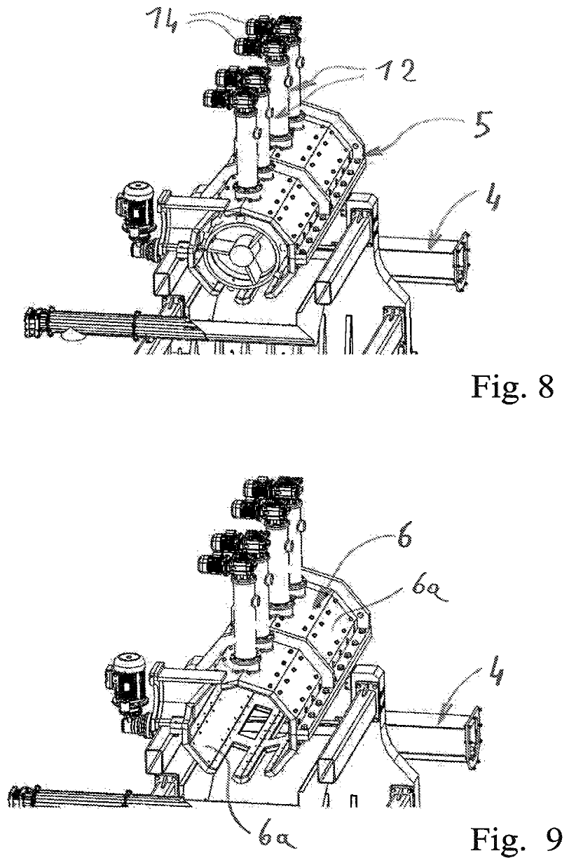

In accordance with the embodiment in FIG. 1, a mill 21 is positioned downstream of the extraction stage 4 for reducing the size of plastic material. Said mill 21 is fed with the plastic material leaving the extraction stage 4.

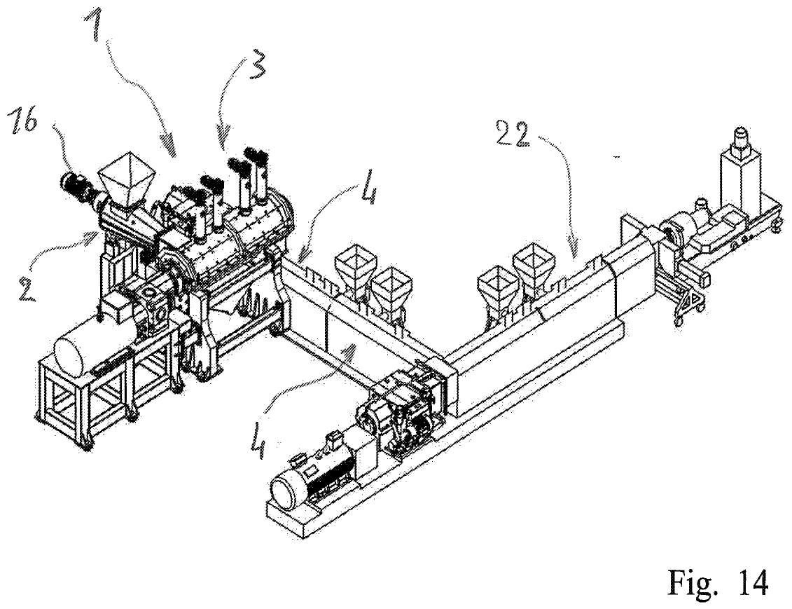

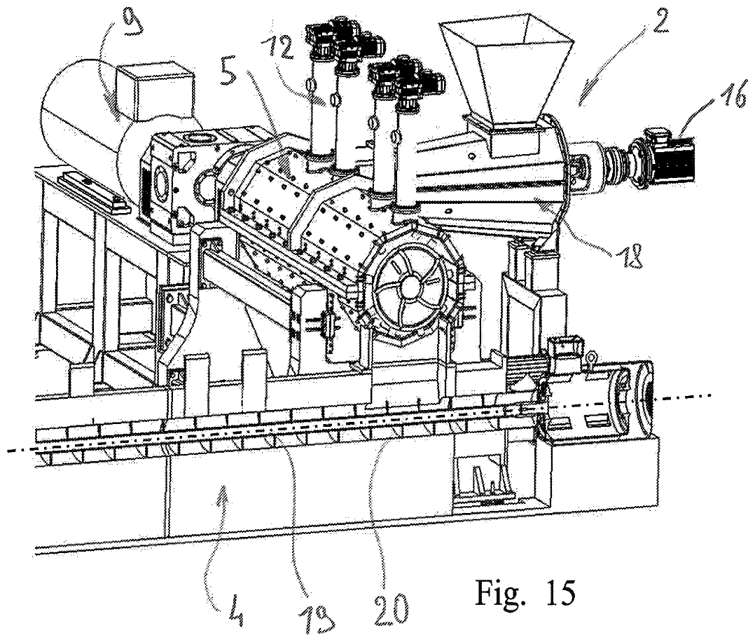

In accordance with an embodiment shown in FIG. 14, the plant 1 also includes an extrusion line 22 positioned downstream of the extraction stage 4 to be fed with the plastic material leaving this extraction stage 4.

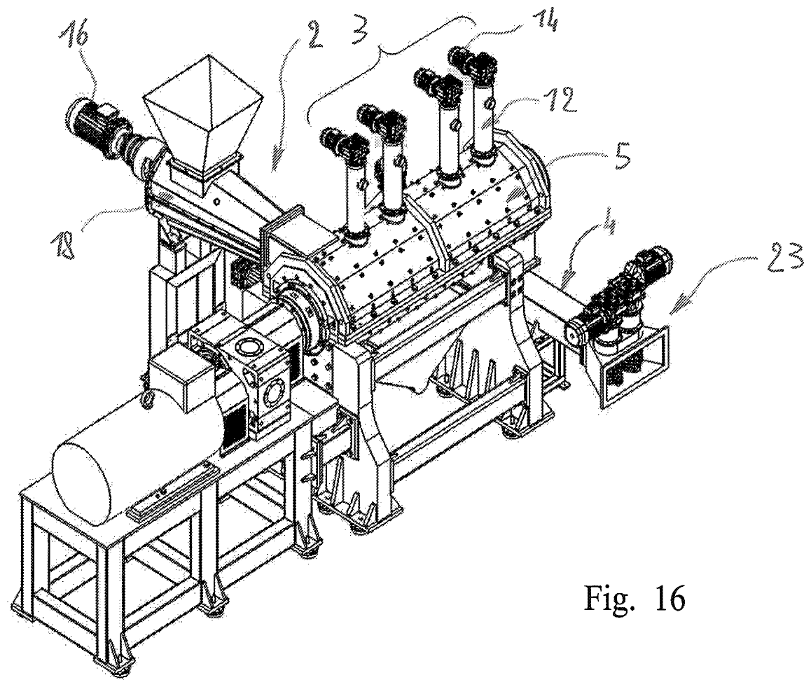

In accordance with the embodiment shown in FIG. 16, the plant 1 also comprises an extractor 23 with double motorized, parallel and counter-rotating rollers, this extractor 23 being positioned at the outlet of the extraction stage 4 to facilitate the discharge of the plastic material from the extraction stage 4 and act mechanically on the homogenized plastic material to reduce its size.

In accordance with the present invention, the method of recycling heterogeneous plastic materials comprises the steps of:
preparing a plastic material to be recycled;
preparing a processing stage 3 of the plastic material to be recycled; —providing a processing stage (3) for processing the plastic material to be recycled;
processing the plastic material to be recycled in the processing stage 3 and
feeding the plastic material to be recycled at processing stage 3;
extracting, by an extraction stage 4, the plastic material processed in said processing stage 3,

wherein the above-mentioned processing stage 3 of the plastic material is subjected to high friction rubbing in a rubbing and drying chamber 5 to achieve a reduction in volume, as well as homogenization with drying of the processed plastic material.

It should be noted that the drying of the processed material inside the above-mentioned rubbing and drying chamber 5 is determined by the temperatures reached inside the cavity 8 as a result of the high friction due to rubbing.

In accordance with a preferred embodiment, the above-mentioned rubbing with high friction of the plastic material that takes place in the rubbing and drying chamber 5 is obtained by making the material to be processed pass through a cavity 8 identified between the internal side of a side wall of the rubbing and drying chamber 5 and the outer side of a side wall of a roller rotor 7 driven in rotation inside the rubbing and drying chamber 5.

Preferably, the roller rotor 7 comprises a plurality of single discontinuous protrusions 10, as previously described, projecting into the cavity 8 to strike the plastic material individually during the processing phase and cause it to homogenize and reduce its volume by rubbing, preferably said single discontinuous projections 10 are single elements axially and angularly offset and spaced apart from each other.

Preferably, the above-mentioned high friction rubbing step is carried out with simultaneous degassing and/or with the addition of additives.

Preferably, the above-mentioned high friction rubbing step is carried out with a simultaneous heating of the plastic material inside the rubbing and drying chamber 5 by means of electric heating means (for example, electric resistors), preferably to ensure a temperature. of at least 150° C., preferably a temperature between 150° C. and 200° C., more preferably to allow the plastic material to be heated inside the above-mentioned rubbing and drying chamber 5 up to a value close to 400° C. in order to ensure, during use, that the complete melting of the plastic material can be ensured inside the above-mentioned rubbing and drying chamber 5.

On this point, it should be pointed out that the high friction rubbing carried out in the rubbing and drying chamber 5 is already in itself suitable for raising the temperatures inside the rubbing and drying chamber 5 up to values of up to 150° C.; however, in accordance with a preferred embodiment, the presence of the heating means (for example, electric resistors) allows the desired temperatures to be reached even in an initial transient phase during the initial start-up of the plant, as well as allows the material to be heated in the cavity 8 even at the above-mentioned values above 150° C.

Preferably, the plastic material to be processed is forced to enter the processing stage 3 by means of a conical feeding screw 15 acting in a conical containment chamber 18, with both tapers oriented so as to converge towards the processing stage 3.

Preferably, the above-mentioned step of feeding the plastic material to be recycled in the above-mentioned processing step 3 is carried out with simultaneous squeezing and draining of this plastic material.

Preferably, the above-mentioned step of extracting the plastic material processed in the processing step 3 by means of an extraction stage 4 is carried out in a forced manner, preferably it is carried out by means of an extraction screw 19 acting in a containment chamber 20.

Preferably, the above-mentioned step of extracting the plastic material processed in the processing step 3 by means of an extraction step 4 is carried out by heating the plastic material in transit in the extraction step 4, preferably to ensure that the processed material is maintained at a temperature of at least 80° C., more preferably to ensure a temperature of the material processed in said extraction stage 4 comprised between 85° C. and 200° C., more preferably to allow the plastic material to be heated inside the extraction stage 4 up to at a value close to 400° C. in order to guarantee, during use, that the complete melting of the plastic material can be ensured inside the extraction stage 4.

Preferably, the method according to the present invention comprises the steps of:
detecting the current absorption of motor means 9 of the rubbing and drying chamber 5;
comparing the current absorption detected with a preset current absorption value and feedback control:
   to increase or decrease the feeding rate of the plastic material to said processing stage 3 according to whether the detected absorption value is lower or higher than said preset current absorption value and/or
   to increase or decrease the extraction rate of the processed plastic material by said extraction stage 4 according to whether the detected absorption value is higher or lower than said preset current absorption value.

It should be noted that the possibility:
to force in an adjustable and controlled way the amount of plastic material introduced into the processing stage 3 through the input stage associated with the loading opening and, at the same time
to be able to carry out in an adjustable and controlled way a forced extraction of the plastic material processed in the processing stage 3 by means of the extraction stage 4 associated with the above-mentioned discharge opening allows to define not only the stay time of the plastic material in the processing stage but also the quantity and compaction of the plastic material inside the material processing chamber during the processing itself, so as to continuously adapt them to the type of plastic material processed.

Therefore, the feature makes it possible to adapt the operation of the machine to the specific type of plastic material present in the processing stage 3, an adaptation that can be handled manually by an operator or, more advantageously, can be carried out automatically on the basis of the current absorption detected, as explained above.

Preferably, downstream of the above-mentioned step of extracting the processed homogeneous plastic material by means of an extraction step 4, this material is subjected:
to a phase of reducing the size and/or
to an extrusion step in an extrusion line 22.

Preferably the method according to the present invention is carried out by means of the plant 1 described above.

As can be appreciated from what has been described, the plant of recycling heterogeneous plastic materials according to the present invention allows to meet the above-mentioned need and, at the same time, to overcome the drawbacks referred to in the introductory part of the present description with reference to the know technique. In fact, the plant described above is able to achieve the homogenization of heterogeneous plastic materials, that is to say of mixed plastics, to be recycled without having to worry about separating them to process them separately, still allowing to obtain a product with homogeneous characteristics suitable for use as raw material for an extrusion or hot stamping phase.

Similar considerations can be referred to the method according to the invention, thanks to the fact that the above-mentioned step of rubbing, homogenizing and drying the plastic material to be recycled makes it possible to meet the needs referred to.

It should be noted that the product obtained with the plant and/or with the method described above can be sent immediately to an extrusion or hot molding line. Alternatively, the recycled plastic material can be stored for a subsequent extrusion or hot molding step.

An advantage of the plant and of the method according to the present invention lies in the simplification of the same and in the possibility of obtaining a recycled raw material that has characteristics suitable for being used in order to be processed in subsequent steps of extrusion or hot molding without having to provide for the addition of plastic material such as polyethylene or other polyolefins.

Obviously, a person skilled in the art, in order to meet contingent and specific needs, will be able to make numerous changes and variations to the plant and/or method described above, all however contained within the scope of the invention as defined by the following claims.

1. A plant for recycling plastic materials comprising:
an infeed stage for feeding in the plastic material to be recycled;
a processing stage for processing the plastic material that has been fed by said infeed stage, and
an extraction stage for extracting the plastic material processed in said processing stage,
wherein said processing stage for plastic material comprises a rubbing and drying chamber for rubbing and drying the plastic material that has been fed, said rubbing and drying chamber being suitable to achieve a volume reduction, and homogenization-drying of the material being processed inside said rubbing and drying chamber, and said plastic material rubbing and drying chamber for plastic material comprising:
a tubular body extending in a prevailing axial direction and having a continuous side wall extending between opposite closed ends;
a roller rotor comprising a continuous side wall axially extending in said axial direction between opposite closed ends, said roller rotor axially extending in said tubular body and being supported in said tubular body to rotate about its own axis, said side wall of said roller rotor is spaced apart from said side wall of the tubular body to define an annular gap in said rubbing and drying chamber, for receiving the plastic material to be subjected to rubbing and homogenization-drying;
motor means for driving said roller rotor to rotate about its own axis inside said rubbing and drying chamber;
a loading opening and a discharge opening for the plastic material to be subjected to rubbing and homogenization-drying, said loading and unloading openings of said rubbing and drying chamber being axially offset from each other in said axial direction and being in fluid communication with each other via said annular gap so that a processing path is defined inside said rubbing and drying chamber between said loading opening and said discharge opening, for the plastic material to be subjected to rubbing and homogenization-drying, said roller rotor comprises a plurality of single discontinuous projections projecting out of said continuous side wall of the roller rotor toward the inner side of said continuous side wall of said tubular body, without contacting said continuous side wall of said tubular body, said single discontinuous projections are single elements which are axially and angularly offset from each other, to hit individually on the plastic material in said gap and to cause homogenization and volume reduction by rubbing of the plastic material.

2. The plant as claimed in claim 1, wherein said loading opening and said discharge opening of said rubbing and drying chamber are positioned at axially distal portions of said continuous side wall of said tubular body.

3. The plant as claimed in claim 1, wherein said roller rotor at the outer side of said opposite ends comprises a plurality of segments radially projecting from a central portion of each end toward a peripheral edge of each end following an inclined/curved path, to thereby cause ejection of any plastic material in the gap, defined between the ends of the roller rotor and the corresponding closed end ends of the tubular body, as said roller rotor rotates.

4. The plant as claimed in claim 1, wherein said rubbing and drying chamber comprises at least one degassing chimney in fluid communication with at least one of said gap and openings for adding additives as the plastic material is being processed.

5. The plant as claimed in claim 4, wherein said degassing chimney comprises a driving screw rotated by motor means, and the helical pattern of said driving screw causing solid material to be transferred/driven toward said gap during rotation.

6. The plant as claimed in claim 1, wherein said rubbing and drying chamber comprises heating means for ensuring heating of the plastic material inside said rubbing and drying chamber to thereby ensure, in operation, full melting of the plastic material inside said rubbing and drying chamber.

7. The plant as claimed in claim 1, wherein at least one of:
said continuous side wall of said tubular body is defined by plates made of wear-resistant steel, and
said tubular body has a polyhedral cross section with flat sides connected in correspondence of respective vertices.

8. The plant as claimed in claim 1, wherein said infeed stage for the plastic material to be recycled comprises a feeding screw operating in a holding chamber, and said feeding screw being driven by motor means to force the introduction of plastic material to be processed into said processing stage with a predetermined adjustable load through said loading opening.

9. The plant as claimed in claim 8, wherein said feeding screw of said infeed stage is a tapering screw operating in a tapering holding chamber, and both tapers being oriented to converge toward said processing stage.

10. The plant as claimed in claim 8, wherein the walls of said holding chamber have one of drainage openings or a net to allow liquid drainage as a result of the pressing and squeezing action exerted by said feeding screw on the plastic material in said holding chamber.

11. The plant as claimed in claim 1, wherein said extraction stage of the plastic material processed in said processing stage is associated with said discharge opening said rubbing and drying chamber.

12. The plant as claimed in claim 1, wherein said extraction stage for extracting the plastic material processed in said processing stage comprises an extraction screw operating in a holding chamber and driven by motor means.

13. The plant as claimed in claim 12, wherein said extraction stage comprises heating means associated with said extraction screw and said holding chamber for ensuring heating of the plastic material flowing in said extraction stage.

14. The plant as claimed in claim 8, wherein said plant comprises:
means for controlling current absorption of said motor means for driving said roller rotor to rotate about its own axis inside said rubbing and drying chamber;
first control means for varying the rotation speed of said motor means of said feeding screw of said infeed stage;
second control means for varying the rotation speed of said motor means of said extraction screw of said extraction stage, and
means for checking current absorption of said motor means of said roller rotor and comparing the current absorption with a preset current absorption value and:
feedback control of said first control means to increase or decrease a rotation speed of said motor means of said feeding screw of said infeed stage according to whether the detected absorption value is lower or higher than said preset current absorption value, and/or
feedback control of said second control means to increase or decrease a rotation speed of said motor means of said extraction screw of said extraction stage according to whether the detected absorption value is higher or lower than said preset current absorption value.

15. The plant as claimed in claim 1, comprising a grinder for reducing a size of plastic material, wherein said grinder is located downstream from said extraction stage to be fed with the plastic material that flows out of said extraction stage.

16. The plant as claimed in claim 1, comprising an extrusion line located downstream from said extraction stage to be fed with the plastic material that flows out of said extraction stage.

17. The plant as claimed in claim 1, comprising an extractor having two parallel and counter-rotating powered rollers, located at the outlet of said extraction stage to facilitate discharge of the processed plastic material from said extraction stage and to mechanically act on said material to reduce its size.

18. A method of recycling heterogeneous plastic materials comprising the steps of:
providing the plastic material to be recycled;
providing a processing stage for processing the plastic material to be recycled;
feeding said plastic material to be recycled to said processing stage;
processing said plastic material to be recycled in said processing stage; and
extracting, by an extraction stage, the plastic material processed in said processing stage,
wherein in said processing stage the plastic material is subjected to high friction rubbing and homogenization-drying in a rubbing and drying chamber to achieve volume reduction and homogenization-drying of the processed plastic material obtained by causing the material to be processed to flow through a gap defined between the inner side of a side wall of said rubbing and drying chamber and the outer side of a side wall of a roller rotor rotated within said rubbing and drying chamber, said roller rotor comprising a plurality of single discontinuous projections projecting into said gap from said continuous side wall of the roller rotor to hit the plastic material being processed and to cause homogenization and volume reduction by rubbing of the plastic material, preferably said single discontinuous projections are single elements which are axially and angularly offset from each other,
wherein:
performing said step of feeding said plastic material to be recycled in said processing stage by forcing and controlling the plastic material fed in said processing stage by means of a feeding screw, and
performing said step of extracting said processed plastic material in said processing stage by means of an extraction stage in a forced and controlled manner.

19. The method as claimed in claim 18, further comprising the step of carrying out said high friction rubbing and homogenization-drying step with simultaneous degassing and/or addition of additives.

20. The method as claimed in claim 18, further comprising the step of carrying out said step of high-friction rubbing and homogenization-drying while heating the plastic material inside said rubbing and drying chamber to thereby ensure, in operation, full melting of the plastic material inside said rubbing and drying chamber.

21. The method as claimed in claim 18, further comprising the step of carrying out said step of feeding said plastic material into said processing stage by forcing and controlling the quantity of plastic material fed via a tapering feeding screw operating in a tapering containing chamber, with both tapers oriented to converge toward said processing stage with simultaneous squeezing and draining of said plastic material.

22. The method as claimed in claim 18, further comprising the step of carrying out said step of extracting the plastic material processed in said processing stage by an extraction stage by means of an extraction screw operating in a holding chamber.

23. The method as claimed in claim 18, further comprising the step of carrying out said step of extracting the plastic material processed in said processing stage by an extraction stage while simultaneously heating the plastic material that flows in said extraction stage to thereby ensure, in operation, full melting of the plastic material inside said extraction stage.

24. The method as claimed in claim 18, comprising the steps of:
detecting current absorption of motor means of said rubbing and drying chamber;
comparing said detected current absorption with a preset current absorption value and providing feedback control:
to increase or decrease the feeding rate of said plastic material to said processing stage according to whether the detected absorption value is lower or higher than said preset current absorption value; and/or
to increase or decrease the extraction rate of the processed plastic material by said extraction stage according to whether the detected absorption value is higher or lower than said preset current absorption value.

25. The method as claimed in claim 18, wherein, after said step of extracting by an extraction stage, the processed homogeneous plastic material is subjected to:
a size reduction step; and/or
an extrusion step in an extrusion line.

26. (canceled)

27. The method as claimed in claim 18, further comprising the step of carrying out said step of high-friction rubbing and homogenization-drying while heating the plastic material inside said rubbing and drying chamber to a temperature close to 400° C. to thereby ensure, in operation, full melting of the plastic material inside said rubbing and drying chamber.
